(19) United States
(12) Patent Application Publication
(10) Pub. No.: US 2026/0076847 A1
(43) Pub. Date: Mar. 19, 2026

(54) FOLDABLE MOBILITY AID

(71) Applicant: Shanq-Ching SHIEH, Yuanlin City (TW)

(72) Inventor: Shanq-Ching SHIEH, Yuanlin City (TW)

(21) Appl. No.: 18/884,806

(22) Filed: Sep. 13, 2024

(51) Int. Cl. A61G 5/08

(52) U.S. Cl. CPC A61G 5/0883

(57) ABSTRACT

A foldable mobility aid has a base, a foldable frame, a first spring-plunger assembly, and a chair. The foldable frame has a first frame-body, a second frame-body, and a guiding assembly. Each of the first and the second frame-body-bodies has a pivoting end pivotally connected to the base and a free end being swingable. The guiding assembly has a rail disposed at the first frame-body and a guiding unit disposed at the second frame-body and movable along the rail. The first spring plunger has a mount fixed to the first frame-body and a spring plunger fixed to the second frame-body. The chair has a seat pivotally connected to one of the first and the second frame-body-bodies. Wherein, a plunger body of the spring plunger is able to engage with an engaging hole of the mount to keep the foldable frame expanded.

### BACKGROUND OF THE INVENTION

### 1. Field of the Invention

The present invention relates to a personal transporter, and more particularly to a mobility aid being foldable.

### 2. Description of Related Art

A mobility aid is a transporter that can be driven by human muscle power or other energies. The mobility aid mainly has a chair, a base, and a stem. A motor is disposed on the base and is configured to power the mobility aid. The stem is configured to steer the mobility aid. The mobility aid can be easily operated and move smoothly and is suitable for elders and people who need mobility aids.

However, a conventional mobility aid is unable or only has a small part to be folded and always occupies quite a large space. Consequently, the conventional mobility aid is difficult to be stored indoors and is hard to be carried about when going out. The conventional mobility aid is inconvenient for the users.

To overcome the shortcomings of the conventional mobility aid, the present invention provides a foldable mobility aid to mitigate or obviate the aforementioned problems.

### SUMMARY OF THE INVENTION

The main objective of the present invention is to provide a mobility aid that is foldable and easy to be stored and carried about.

The foldable mobility aid has a base, a foldable frame, a first spring-plunger assembly, and a chair. The foldable frame has a first frame-body, a second frame-body, and a guiding assembly. Each of the first and the second frame-body-bodies has a pivoting end pivotally connected to the base and a free end being swingable. The guiding assembly has a rail disposed at the first frame-body and a guiding unit disposed at the second frame-body and movable along the rail. The first spring plunger has a mount fixed to the first frame-body and a spring plunger fixed to the second frame-body. The chair has a seat pivotally connected to one of the first and the second frame-body-bodies. Wherein, a plunger body of the spring plunger is able to engage with an engaging hole of the mount to keep the foldable frame expanded.

Other objects, advantages, and novel features of the invention will become more apparent from the following detailed description when taken in conjunction with the accompanying drawings.

### BRIEF DESCRIPTION OF THE DRAWINGS

FIG. 1 is a first perspective view of the foldable mobility aid in accordance with the present invention and shows that the foldable mobility aid is expanded;

FIG. 2 is a second perspective view of the foldable mobility aid in FIG. 1 and shows that the foldable mobility aid is expanded;

FIG. 3 is a third perspective view of the foldable mobility aid in FIG. 1 and shows that the foldable mobility aid is expanded;

FIG. 4 is a side view of the foldable mobility aid in FIG. 1 and shows that the foldable mobility aid is expanded;

FIG. 5 is a first enlarged perspective view of a foldable frame of the foldable mobility aid in FIG. 1;

FIG. 6 is a second enlarged perspective view of the foldable frame of the foldable mobility aid in FIG. 1;

FIG. 7 is a third enlarged perspective view of the foldable frame of the foldable mobility aid in FIG. 1;

FIG. 8 is a partial perspective view of the foldable mobility aid in FIG. 1;

FIG. 9 is another partial perspective view of the foldable mobility aid in FIG. 1;

FIG. 10 is an enlarged perspective view of a latching assembly of the foldable mobility aid in FIG. 1;

FIG. 11 is a perspective view of the foldable mobility aid in FIG. 1 and shows that the foldable mobility aid is folded;

FIG. 12 is an enlarged perspective view of a chair of the foldable mobility aid in FIG. 1 and shows that the chair is folded;

FIG. 13 is another enlarged perspective view of the chair of the foldable mobility aid in FIG. 1 and shows that the chair is expanded;

FIG. 14 is a fourth perspective view of the foldable mobility aid in FIG. 1 and shows that the foldable mobility aid is expanded;

FIG. 15 is another side view of the foldable mobility aid in FIG. 1 and shows that the foldable mobility aid is folded;

FIG. 16 is an enlarged perspective view of a handle of the foldable mobility aid in FIG. 1 and shows that the handle is folded; and

FIG. 17 is another enlarged perspective view of a handle of the foldable mobility aid in FIG. 1 and shows that the handle is expanded.

### DETAILED DESCRIPTION OF PREFERRED EMBODIMENTS

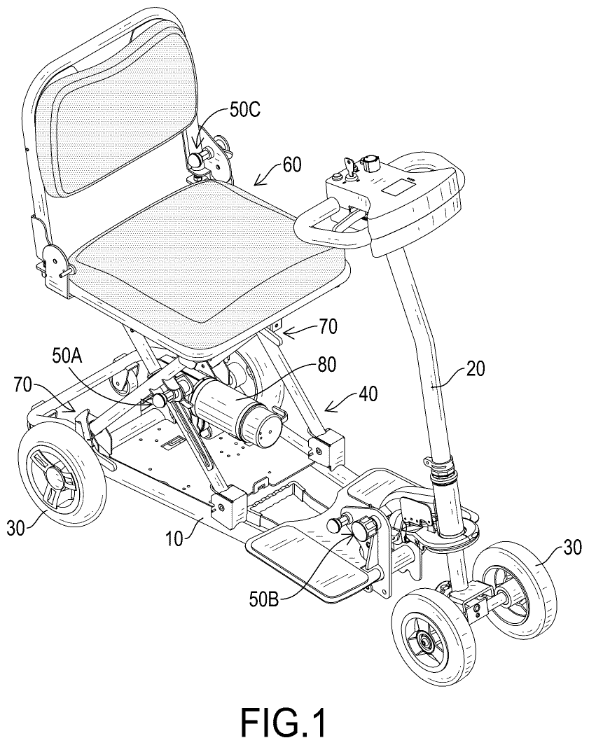

With reference to FIGS. 1 to 3, a foldable mobility aid in accordance with the present invention is configured to be used by elders and people who need rehabilitation. The foldable mobility aid has a base 10, a stem 20, four wheels 30, a foldable frame 40, a first spring-plunger assembly 50A, a chair 60, two latching assemblies 70, a driving device 80, and a handle 90.

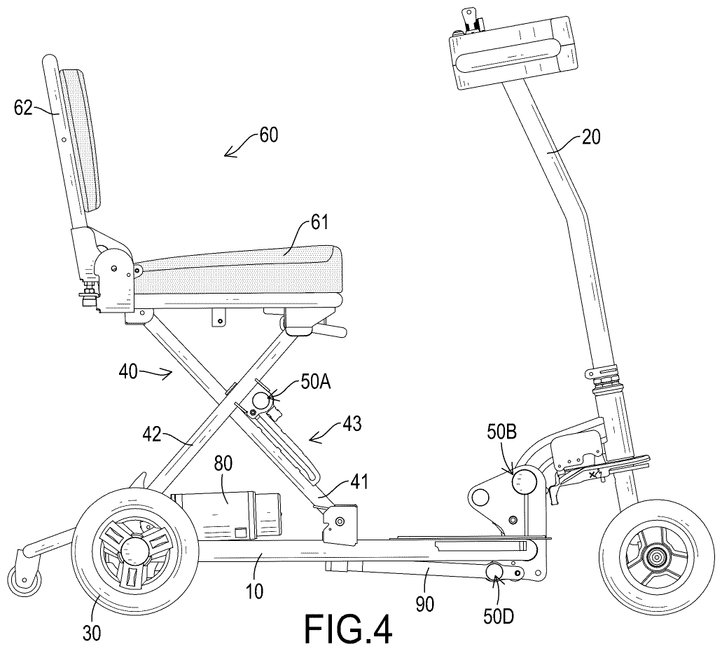

With reference to FIGS. 1 to 4, the base 10 has a front end and a rear end opposite to each other in position, and a middle section disposed between the front and the rear ends of the base 10. The stem 20 is disposed at the front end of the base 10. Two of the wheels 30 are rotatably disposed at the rear end of the base 10. The others of the wheels 30 are rotatably disposed at a bottom of the stem 20.

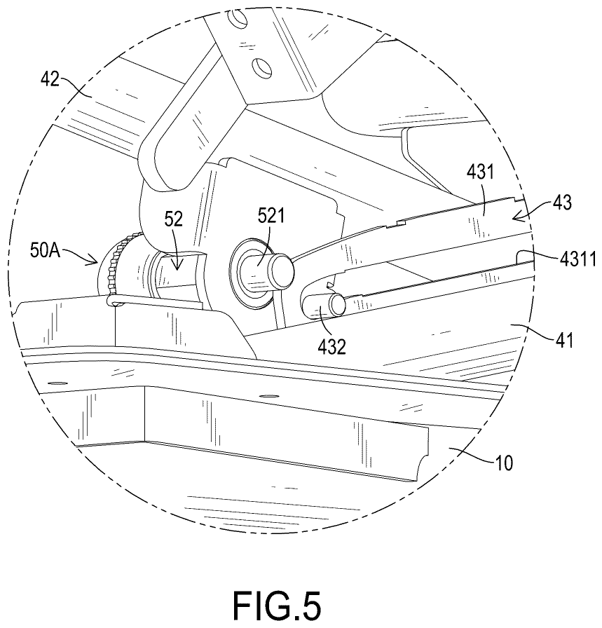

With reference to FIGS. 1 to 4, the foldable frame 40 is assembled to the base 10 and has a first frame-body 41, a second frame-body 42, and a guiding assembly 43. The first frame-body 41 has a pivoting end and a free end opposite to each other in position. The pivoting end of the first frame-body 41 is pivotally assembled to the middle section of the base 10, and the free end of the first frame-body 41 is swingable toward the front and the rear ends of the base 10. The second frame-body 42 also has a pivoting end and a free end opposite to each other in position. The pivoting end of the second frame-body 42 is pivotally connected to the rear end of the base 10, and the free end of the second frame-body 42 is swingable toward the front and the rear ends of the base 10. With reference to FIGS. 5 to 7, the guiding assembly 43 has a rail 431 and a guiding unit 432. The rail 431 is disposed at the first frame-body 41 and has a guiding hole 4311. The rail 431 and the guiding hole 4311 thereof extend toward the pivoting end and the free end of the first frame-body 41. The guiding unit 42 is shaped as a pillar, is disposed at the second frame-body 42, is inserted in the guiding hole 4311 of the rail 431, and is movable along the rail 431.

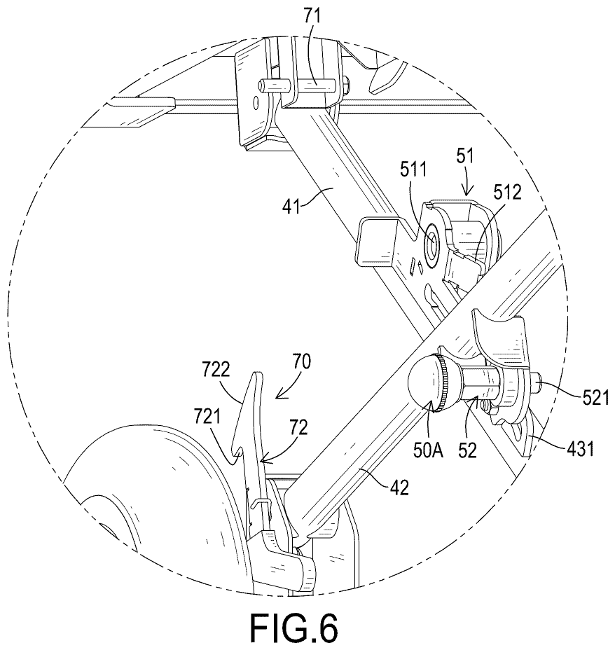

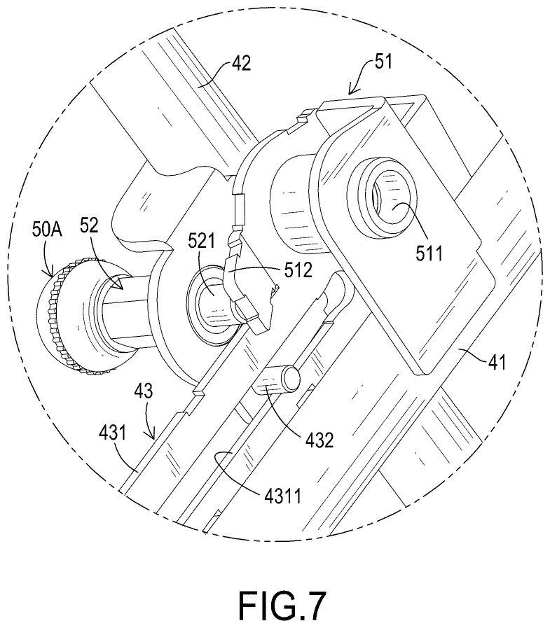

With reference to FIG. 1, and 4 to 7, the first spring-plunger assembly 50A has a mount 51 and a spring plunger 52. The mount 51 is fixed to the first frame-body 41 and has an engaging hole 511 and a guiding plate 512 being oblique. The spring plunger 52 is fixed to the second frame-body 42 and has a plunger body 521 shaped as a pin. The spring plunger 52 is pushed by a compression spring (not shown) and configured to be inserted in the engaging hole 511 to engage with the engaging hole 511. With reference to FIG. 5, when the foldable frame 40 is folded, the plunger body 521 of the spring plunger 52 does not engage with the engaging hole 511. With reference to FIGS. 6 and 7, when the foldable frame 40 gradually expands, the guiding unit 432 inserted in the guiding hole 4311 of the rail 431 moves along the rail 431. When the plunger body 521 of the first plunger assembly 50A contacts the guiding plate 512, the compression spring of the spring plunger 52 is gradually compressed, and the plunger body 521 is guided by the guiding plate 512 and inserted in the engaging hole 511 to keep the foldable frame 40 expanded.

With reference to FIGS. 1 to 4, the chair 60 has a seat 61 and a back 62. Wherein, the seat 61 has a front side and a rear side opposite to each other in position. The rear side of the seat 61 is pivotally connected to the free end of the second frame-body 42. The back 62 is disposed at the rear side of the seat 61.

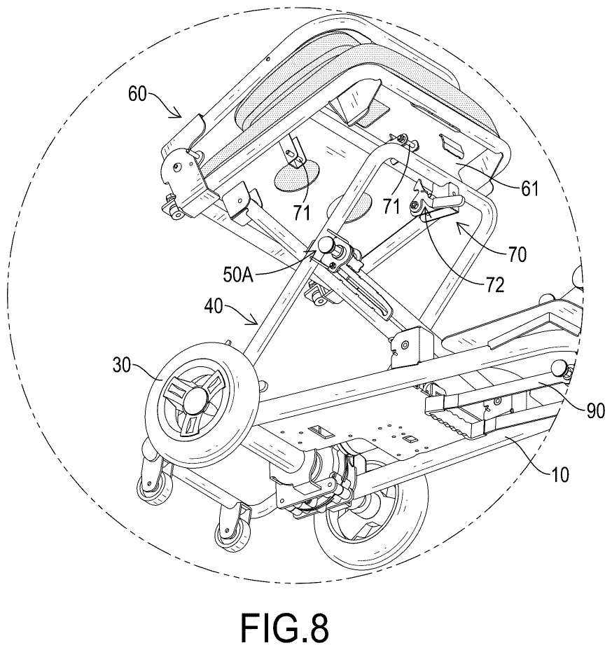

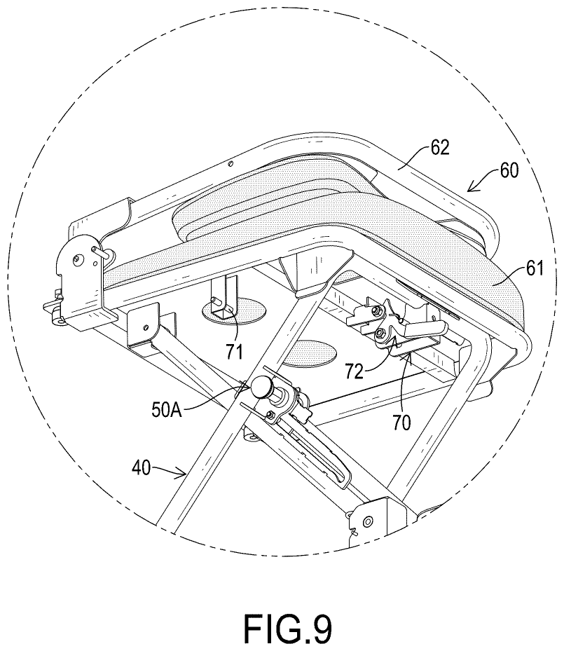

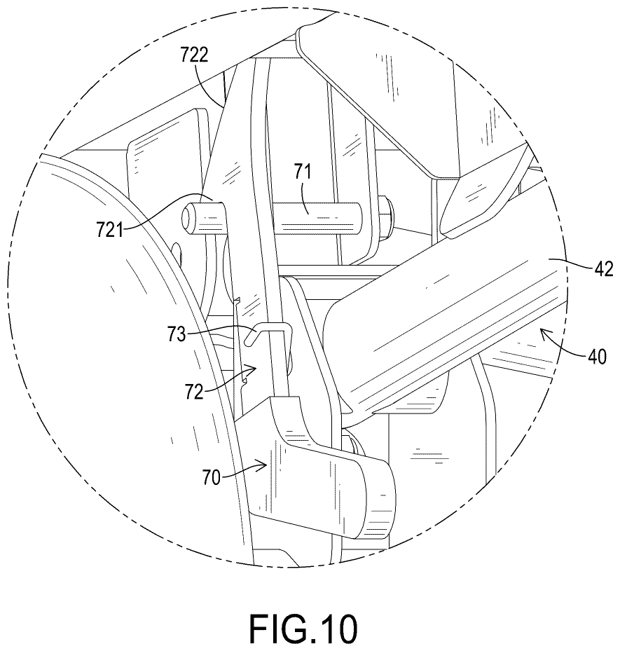

With reference to FIGS. 1, 6, and 8 to 10, each latching assembly 70 has a hooked unit 71 and a hooking unit 72 to be pushed by a torsion spring 73 to pivot and hook the hooked unit 71. Wherein, the hooked unit 71 is shaped as a stick. The hooking unit 72 has a hooking portion 721 configured to hook the hooked unit 71 and a guiding rim 722 configured to guide the hooked unit 71 when the hooked unit 71 and the hooking unit 72 move relative to each other. When the hooked unit 71 and the hooking unit 72 of each latching assembly 70 move toward each other, the hooked unit 71 can abut the guiding rim 722 of the hooking unit 72 to push the hooking unit 72 to rotate and to expand the torsion spring 73. When the hooked unit 71 and the hooking unit 72 no longer contact each other, the torsion spring 73 restores and pushes the hooking unit 72 to hook the hooked unit 71.

With reference to FIGS. 1, 8, and 9, the hooked unit 71 of one of the two latching assemblies 70 is fixed to a bottom of the seat 61 and is adjacent to the front side of the seat 61, and the hooking unit 72 of the latching assembly 70 is pivotally connected to the free end of the first frame-body 41. The hooking unit 72 can be pushed by the torsion spring 73 and able to hook the hooked unit 71 adjacent to the front side of the seat 61.

With reference to FIGS. 1, 6, and 10, the hooked unit 71 of the other one of the two latching assemblies 70 is fixed to the bottom of the seat 61 and at a middle portion of the seat 61. The hooking unit 72 of the latching assembly 70 is pivotally connected to the base 10 and can be pushed by the torsion spring 73 of the latching assembly 70 to hook the hooked unit 71 at the middle portion of the seat 61.

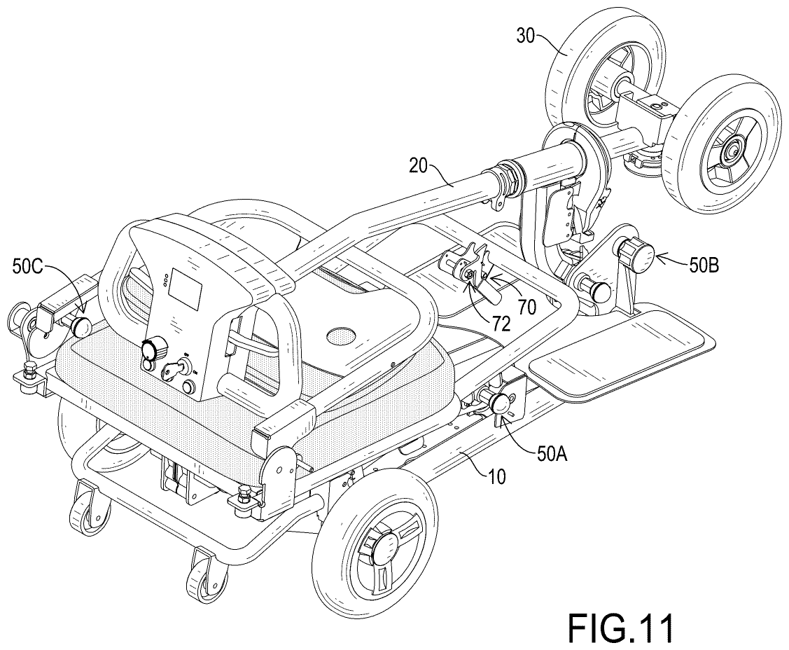

With reference to FIGS. 1, 2, and 11, in the embodiment of the present invention, the stem 20 is pivotally connected to the base 10 and can be folded relative to the base 10. Specifically, a second spring-plunger assembly 50B is deployed between the stem 20 and the base 10. The second spring-plunger assembly 50B is similar to the first spring-plunger assembly shown in FIGS. 5 to 7. The second spring-plunger assembly 50B also has a mount 51 and a spring plunger 52. The mount 51 of the second spring-plunger assembly 50B also has one said engaging hole 511 and one said guiding plate 512 being oblique. The spring plunger 52 of the second spring-plunger assembly 50B also has one said plunger body 521 which can be pushed by one said compression spring (not shown) to be inserted in and engaging with the engaging hole 511. Wherein, the mount 51 of the second plunger assembly 50B is fixed to the stem 20, and the spring plunger 52 is fixed to the base 10. When the stem 20 is expanded, the mount 51 and the spring plunger 52 of the second spring-plunger assembly 50B engage with each other to keep the stem 20 expanded.

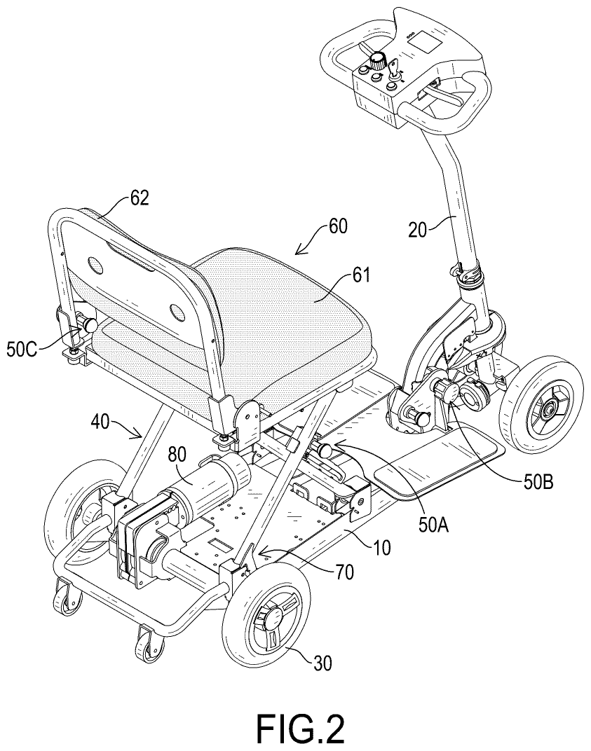

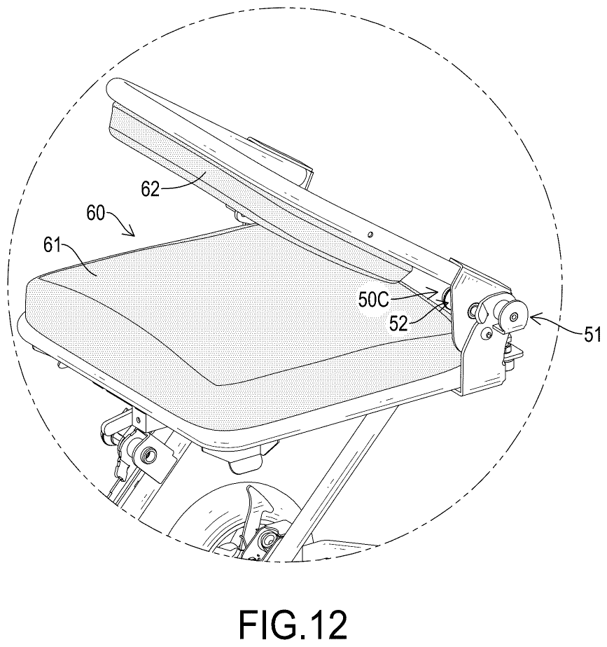

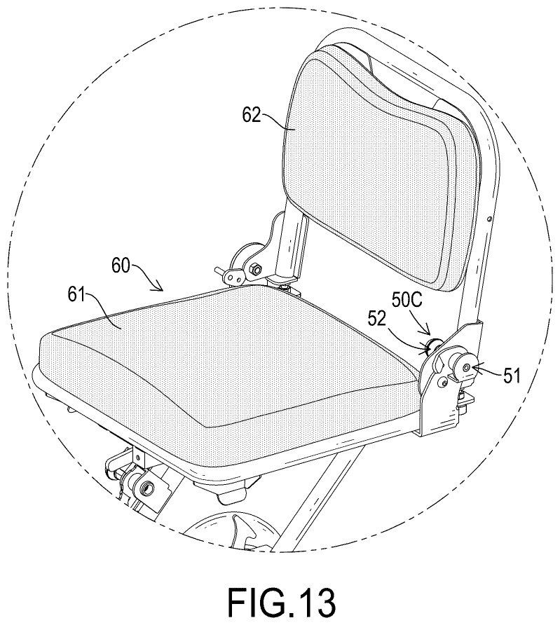

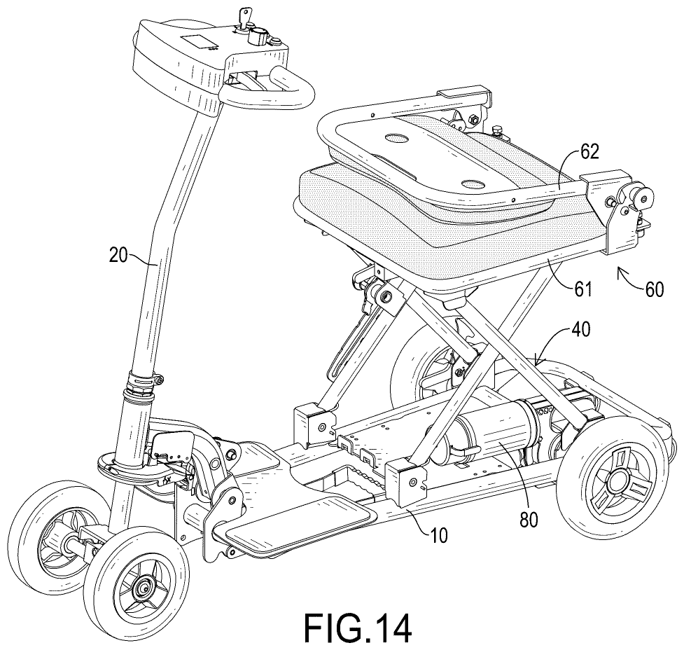

With reference to FIGS. 2 and 12 to 14, in the embodiment of the present invention, the back 62 of the chair 60 is pivotally connected to the seat 61 and is foldable relative to the seat 61. Specifically, a third spring-plunger assembly 50C, similar to the first and the second spring-plunger assemblies 50A, 50b, is disposed between the seat 61 and the back 62. Wherein, the mount 51 of the third spring-plunger assembly 50C is fixed to the seat 61, and the spring plunger 52 is fixed to the back 62. When the chair 60 is expanded, the mount 51 and the spring plunger 52 of the third spring-plunger assembly 50C engage with each other to keep the chair expanded.

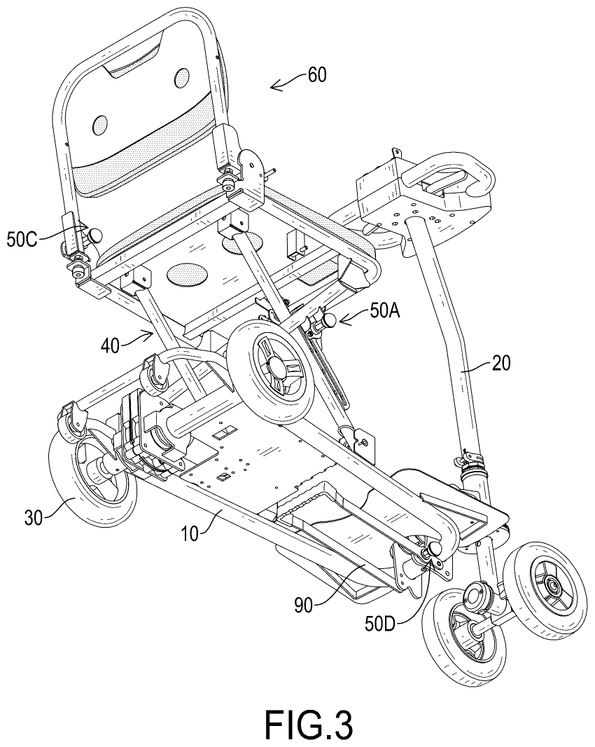

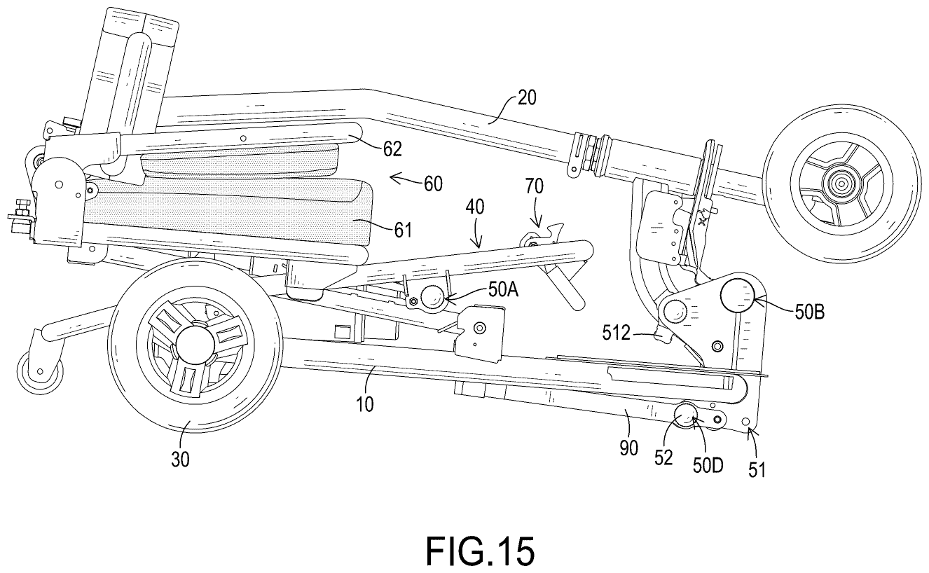

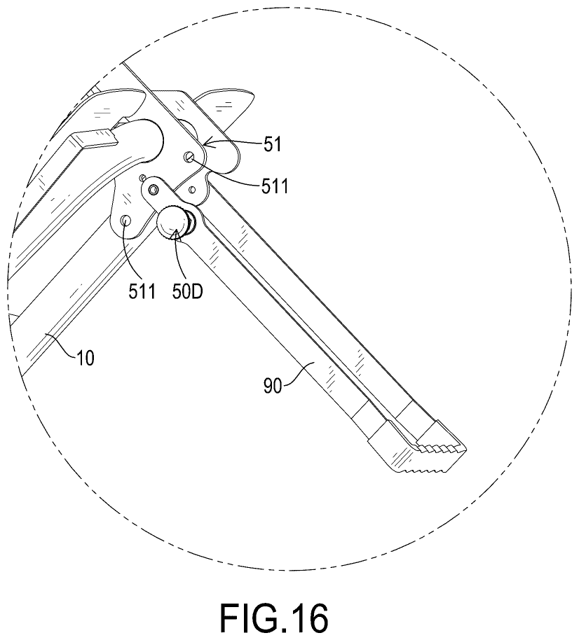

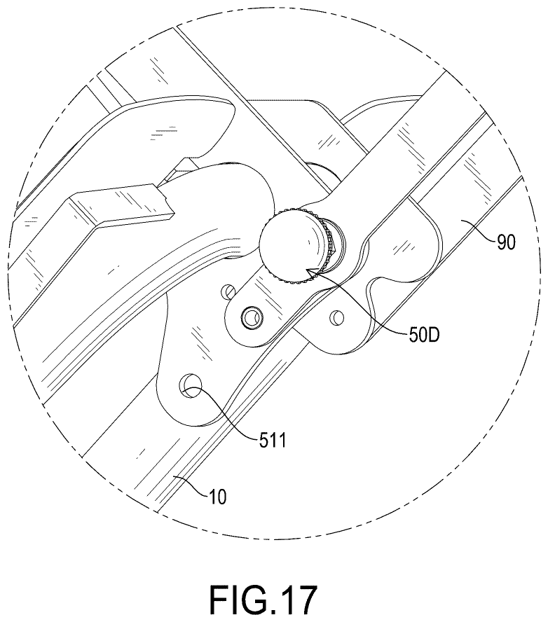

With reference to FIGS. 3, 4, and 15 to 17, in the embodiment of the present invention, the handle 90 is pivotally connected to the base 10 and is foldable relative to the base 10. Specifically, a fourth spring-plunger assembly 50D is disposed between the handle 90 and the base 10. The fourth spring-plunger assembly 50D is similar to the first, the second, and the third spring plungers 50A, 50B, 50C. Wherein, the mount 51 of the fourth spring-plunger assembly 50D is fixed to the base 10 and has two said engaging holes 511. The spring plunger 52 of the fourth spring-plunger assembly 50D is fixed to the handle 90. When the handle 90 is folded, said plunger body 521 of the spring plunger 52 of the fourth spring-plunger assembly 50D is inserted into one of the two engaging holes 511 of the mount 51 of the fourth spring-plunger assembly 50D to keep the handle 90 folded. When the handle 90 is expanded, the plunger body 521 of the spring plunger 52 of the fourth plunger assembly 50D is inserted into the other engaging hole 511 of the mount 51 to engage the mount 51 and the spring plunger 52 to keep the handle 90 expanded.

With reference to FIGS. 1 and 2, the driving device 80 may be implemented as a motor. The driving device 80 is fixed to the base 10 and is connected to the two wheels 30 disposed at the rear end of the base 10. The driving device 80 is configured to drive said wheels 30 and to power the foldable mobility aid of the present invention.

Compared with the conventional mobility aid that cannot be folded, the foldable frame 40 of the present invention is disposed between the base 10 and the chair 60. When the foldable frame 40 expands, the first frame-body 41 and the second frame-body 42 are crossed to support the chair 60 thereon for the user to be seated. When the foldable frame 40 is folded, the first frame-body 41 and the second frame-body 42 are close to the base 10 to minimize the space occupied by the foldable mobility aid of the present invention. The foldable mobility aid of the present invention is easily stored and carried around accordingly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A foldable mobility aid comprising:
a base having a front end and a rear end opposite each other;
a stem disposed at the front end of the base;
at least three wheels, two of the at least three wheels rotatably disposed at the rear end of the base, the rest of the at least three wheels rotatably disposed at the stem;
a foldable frame having
a first frame-body having a pivoting end and a free end opposite to each other in position, the pivoting end of the first frame-body pivotally connected to the base, and the free end of the first frame-body swingable toward the front end and the rear end of the base;
a second frame-body having a pivoting end and a free end opposite to each other in position, the pivoting end of the second frame-body pivotally connected to the base, and the free end of the second frame-body swingable toward the front end and the rear end of the base;
a guiding assembly having
a rail disposed at the first frame-body and extending to the pivoting end and the free end of the first frame-body; and
a guiding unit disposed at the second frame-body and movable along the rail;
a first spring-plunger assembly having
a mount fixed to the first frame-body and having an engaging hole; and
a spring plunger fixed to the second frame-body and having a plunger body configured to engage with the engaging hole; and
a chair having a seat pivotally connected to one of the first frame-body and the second frame-body.

2. The foldable mobility aid as claimed in claim 1, wherein
the rail has a guiding hole extending toward the pivoting end and the free end of the first frame-body; and
the guiding unit is shaped as a pillar and is inserted in the guiding hole to move along the rail.

3. The foldable mobility aid as claimed in claim 2, wherein the foldable mobility aid has a first latching assembly having
a hooked unit shaped as a stick and disposed at a bottom of the seat; and
a hooking unit pivotally connected to the first frame-body and configured to be pushed by a torsion spring to hook the hooked unit of the first latching assembly.

4. The foldable mobility aid as claimed in claim 3, wherein the foldable mobility aid has a second latching assembly having
a hooked unit shaped as a stick and disposed at the bottom of the seat; and
a hooking unit pivotally connected to the base and configured to be pushed by a torsion spring to hook the hooked unit of the second latching assembly.

5. The foldable mobility aid as claimed in claim 4, wherein each hooking unit of the first latching assembly and the second latching assembly has a guiding rim to guide the hooked unit of a corresponding one of the first latching assembly and the second latching assembly.

6. The foldable mobility aid as claimed in claim 1, wherein the foldable mobility aid has a first latching assembly having
a hooked unit shaped as a stick and disposed at a bottom of the seat; and
a hooking unit pivotally connected to the first frame-body and configured to be pushed by a torsion spring to hook the hooked unit of the first latching assembly.

7. The foldable mobility aid as claimed in claim 6, wherein the foldable mobility aid has a second latching assembly having
a hooked unit shaped as a stick and disposed at the bottom of the seat; and
a hooking unit pivotally connected to the base and configured to be pushed by a torsion spring to hook the hooked unit of the second latching assembly.

8. The foldable mobility aid as claimed in claim 7, wherein each hooking unit of the first latching assembly and the second latching assembly has a guiding rim to guide the hooked unit of a corresponding one of the first latching assembly and the second latching assembly.

9. The foldable mobility aid as claimed in claim 1, wherein the foldable mobility aid has a latching assembly having
a hooked unit shaped as a stick and disposed at the bottom of the seat; and
a hooking unit pivotally connected to the base and configured to be pushed by a torsion spring to hook the hooked unit of the latching assembly.

10. The foldable mobility aid as claimed in claim 9, wherein the hooking unit has a guiding rim to guide the hooked unit.

11. The foldable mobility aid as claimed in claim 1, wherein
the stem is pivotally connected to the base and is foldable relative to the base;
a second spring-plunger assembly is disposed between the stem and the base;
a mount of the second spring-plunger assembly is fixed to the stem and has an engaging hole; and
a spring plunger of the second spring-plunger assembly is fixed to the base and has a plunger body configured to engage with the engaging hole of the mount of the second spring-plunger assembly.

12. The foldable mobility aid as claimed in claim 1, wherein
the chair has a back disposed at a rear side of the seat;
a second spring-plunger assembly is disposed between the seat and the back;
a mount of the second spring-plunger assembly is fixed to the seat and has an engaging hole; and
a spring plunger of the second spring-plunger assembly is fixed to the back and has a plunger body configured to engage with the engaging hole of the mount of the second spring-plunger assembly.

13. The foldable mobility aid as claimed in claim 1, wherein
the foldable mobility aid has a handle pivotally connected to the base and foldable relative to the base;
a second spring-plunger assembly is disposed between the handle and the base;
a mount of the second spring-plunger assembly is fixed to the base and has two engaging holes; and
a spring plunger of the second spring-plunger assembly is fixed to the handle and has a plunger body configured to engage with one of the two engaging holes of the mount of the second spring-plunger assembly.
